(19) United States
(12) Patent Application Publication
(10) Pub. No.: US 2014/0146168 A1
(43) Pub. Date: May 29, 2014

(54) METHOD FOR DISPLAYING IMAGES OF A REVERSE VIEW CAMERA SYSTEM OF A MOTOR VEHICLE ON A DISPLAY

(71) Applicant: GM GLOBAL TECHNOLOGY OPERATIONS LLC, Detroit, MI (US)

(72) Inventor: Juergen Fritsch, Ginsheim-Gustavsburg (DE)

(73) Assignee: GM GLOBAL TECHNOLOGY OPERATIONS LLC, Detroit, MI (US)

(21) Appl. No.: 14/081,279

(22) Filed: Nov. 15, 2013

(30) Foreign Application Priority Data
Nov. 15, 2012 (DE) 10 2012 022 319.6

(51) Int. Cl. G06T 11/60; H04N 7/18

(52) U.S. Cl. CPC G06T 11/60; H04N 7/183
USPC 348/118

(57) ABSTRACT

A method is provided for displaying images from a reverse view camera system of a motor vehicle on a display, which includes, but is not limited to generating an image of a rearward environment of the motor vehicle with the aid of the reverse view camera system, providing an information system in the motor vehicle, displaying the image of the rearward environment on the display, and displaying a parameter associated with the information system on the display whilst driving.

### CROSS-REFERENCE TO RELATED APPLICATION

This application claims priority to German Patent Application No. 10 2012 022 319.6, filed Nov. 15, 2012, which is incorporated herein by reference in its entirety.

### TECHNICAL FIELD

The technical field relates to a method for displaying images of a reverse view camera system of a motor vehicle on a display.

### BACKGROUND

Modern motor vehicles are often equipped with displays in the area of a dashboard, on which a variety of information can be displayed. As such it is possible to use the display as an indicator unit for an audio system or a navigation system. Furthermore reverse view camera systems are known which are suitable for displaying a rear area of a motor vehicle on a display.

DE 10 2010 020 201 A1 discloses a method and a device for displaying the images of a reverse view camera system in a motor vehicle. On a display arranged within the field of view of the driver, displaying the images of the reverse view camera system on the display is a function of the driving mode of the motor vehicle, wherein the motor vehicle comprises at least two driving modes that are a function of the motor vehicle speed. Each driving mode comprises at least two driving states.

In view of the foregoing, at least one object is to provide a method for displaying the images of a reverse view camera system that allows for the display of further items of information. In addition, other objects, desirable features, and characteristics will become apparent from the subsequent summary and detailed description, and the appended claims, taken in conjunction with the accompanying drawings and this background.

### SUMMARY

A method is provided for displaying images of a reverse view camera system on a display. The reverse view camera system generates an image of a rearward environment of a motor vehicle. An information system is provided in the motor vehicle. The image of the rearward environment is displayed on the display and at least one of the parameters associated with the information system is displayed on the display during a driving operation.

The method permits using a single display for both the image of a rearward environment of the motor vehicle and for an information system. Accordingly there is provided a possibility for displaying not only the rearward environment whilst driving, but also a parameter associated with the information system, so that both these items of information are shown simultaneously on one display. Displaying the rearward environment whilst driving has proven to be advantageous in comparison to using a rear mirror since the displayed area of the rearward environment normally provides more information content and thus allows the driver to obtain a better view. As a result it is possible, according to the invention, to omit the conventional inside mirror of a motor vehicle.

In one embodiment the information system provided is an audio system. An audio system is frequently provided in a motor vehicle and, according to the invention, is connected with the display so that parameters of the audio system can be shown on the display. In a further embodiment a selected radio station is displayed as a parameter.

Often, radio transmitters utilize a radio service system, which apart from transmitting sound programs also offers additional information. These additional items of information are available both for analogue and for digital transmission protocols. According to the invention the selected radio station is shown on the display.

In a further embodiment the parameter shown is a music title. The display of music titles is perceived by the occupants of the vehicle as pleasant and can be displayed together with the image of the rearward environment whilst driving.

In a further embodiment the information system is provided as a navigation system. Navigation systems are often part of additional or basic equipment. According to the invention a parameter can be displayed together with the image of the rearward environment whilst driving.

In a further embodiment the information system is provided as a navigation map. Navigation systems normally use a digitized map for displaying the driving route. The navigation map can be displayed together with other parameters of the information system.

In a further embodiment generation of the image of the rearward environment of the motor vehicle is interrupted whilst an input is taking place at the information system. Accordingly it is possible to utilize the full size of the display whilst an input is taking place at the information system. This increases operator comfort and permits reliable input of relevant information.

In a further embodiment the driving operation encompasses forward driving or a standstill of the motor vehicle. With this embodiment the rearward environment and the parameter of the information system can only be displayed on the display when driving forward or when the vehicle is at a standstill. In these cases it is perceived as not really causing any discomfort if the display is divided into several areas, since the rearward environment in these cases needs to be watched only briefly by performing quick control checks.

In a further embodiment, if the driving operation is an act of reversing, the display of the parameter associated with the information system is interrupted. When reversing the car the driver is required to devote all his attention to the rearward environment. This is made easier if the display of the parameter associated with the information system is interrupted.

In a further embodiment, if the car is being reversed, the information displayed on the display originates from a parking assistance system. Parking assistance systems often comprise displaying vehicles adjacent to the parking space or the parking space. According to an embodiment this information can be displayed in addition to the rearward environment.

The methods described as well as the advantageous embodiments may be provided in a motor vehicle, in particular in a control unit for a display. The control unit may comprise a digital microprocessor unit (CPU) equipped with a data link to a storage system and a bus system, as well as a memory (RAM) and a storage means. The CPU is configured to process commands executed as a program stored in a storage system, to record input signals from the data bus and to deliver output signals to the data bus. The storage system may comprise various storage media such as optical, magnetic, solid-body media and other non-volatile media, on which an appropriate computer program is stored for executing the method and its advantageous designs. The program may be configured such that it embodies the method herein described or is capable of its execution so that the CPU can execute the steps of such methods and can use it to steer the motor vehicle.

A suitable computer program for performing the method is a program which comprises program code means in order to perform all steps of any of the claims when the program is executed on a computer. The computer program can be imported into an already existing control unit and can be utilized to control a display.

To this end a computer program product is provided with program code means which are stored on a computer-readable medium in order to perform the method according to any one of the claims when the computer program product is executed on a computer. The computer program product can also be integrated with control units as an upgrade option.

A further embodiment relates to an apparatus for displaying images of a reverse view camera system of a motor vehicle on a display, comprising: a production device for producing an image of a rearward environment of the motor vehicle with the aid of the reverse view camera system, an information system in the motor vehicle, a display for displaying the image of the rearward environment on the display, and a display for displaying at least one parameter associated with the information system on the display during driving.

In one embodiment of the apparatus the information system provided is an audio system. In a further embodiment of the apparatus the parameter displayed is a radio station. In a further embodiment of the apparatus the parameter displayed is a music title. In a further embodiment of the apparatus the information system provided is a navigation system. In a further embodiment of the apparatus the parameter displayed is a navigation map. In a further embodiment of the apparatus generation of the image of the rearward environment of the motor vehicle is interrupted, whilst making an input into the information system. In a further embodiment of the apparatus the driving operation encompasses a forward drive or a standstill of the motor vehicle. In a further embodiment of the apparatus, if the driving operation comprises an act of reversing, the display of the parameter associated with the information system on the display is interrupted.

### BRIEF DESCRIPTION OF THE DRAWINGS

The present invention will hereinafter be described in conjunction with the following drawing figures, wherein like numerals denote like elements, and:

FIG. 1 shows a cross-sectional view of a motor vehicle for explaining the method according to an embodiment;

FIG. 2 shows a view of a display according to an embodiment of the method according to an embodiment;

FIG. 3 shows a further view of a display according to an embodiment of the method according to an embodiment;

FIG. 4 shows a further view of a display according to an embodiment of the method according to an embodiment; and

FIG. 5 shows an embodiment of the method according to an embodiment in a flow diagram.

### DETAILED DESCRIPTION

The following detailed description is merely exemplary in nature and is not intended to limit application and uses. Furthermore, there is no intention to be bound by any theory presented in the preceding background or summary or the following detailed description.

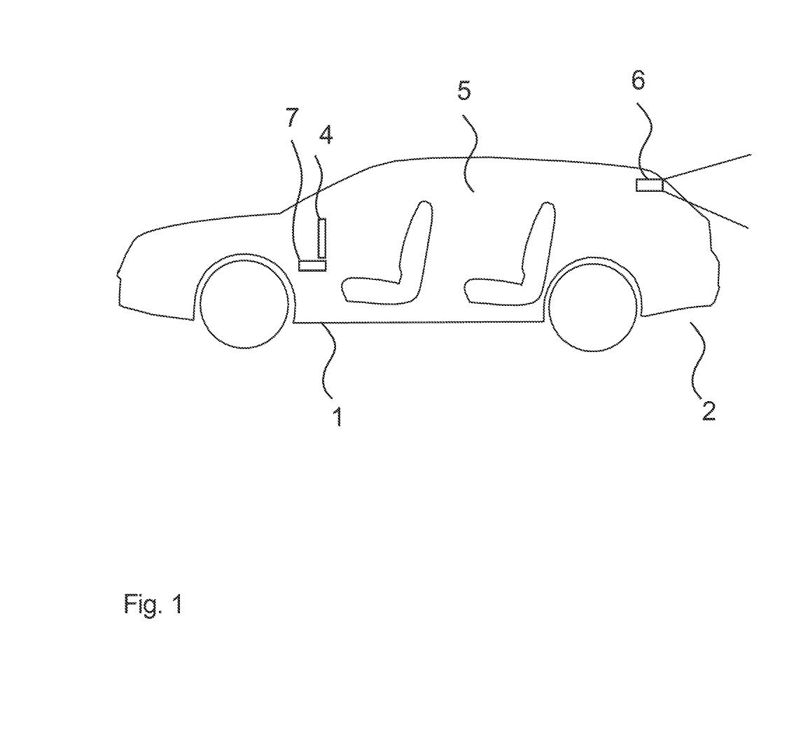

FIG. 1 shows a cross-sectional view of a motor vehicle which will now be used to explain the method according to an embodiment. The motor vehicle 1, at its rear end 2, comprises a reverse view camera system 3 that is capable of displaying on a display 4 an image of a rearward environment of the motor vehicle 1. The display 4 is arranged in a passenger compartment 5 of the motor vehicle 1 so that it can be observed by a driver of the motor vehicle 1.

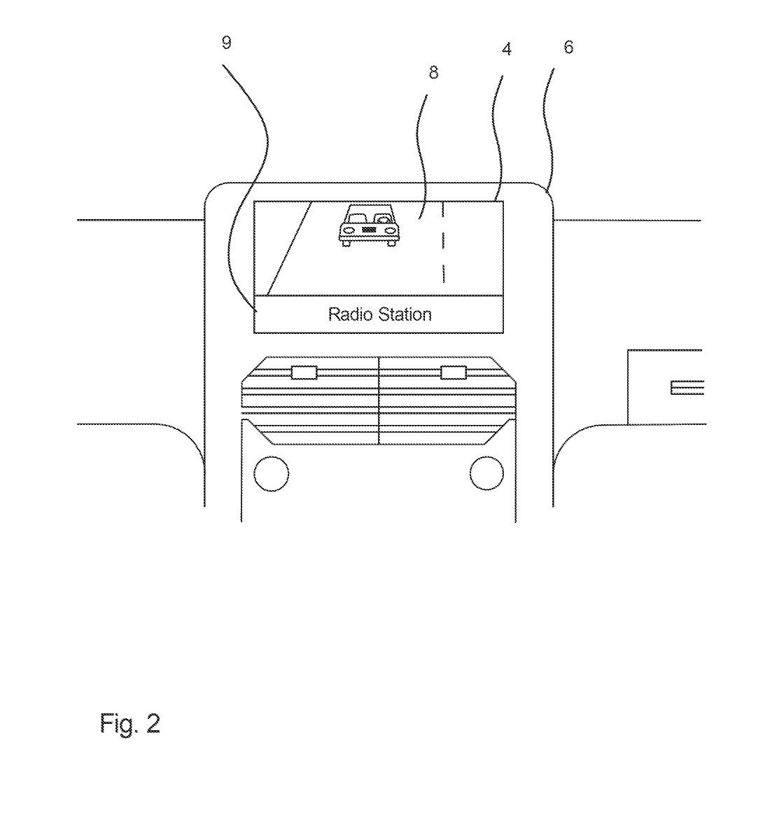

The display 4 is normally arranged in a center console 6 as shown in FIG. 2. However, provision is also made for the display 4 to be retractable in a dashboard, for example, wherein it can be lifted out of the dashboard when the motor vehicle 1 is placed into operation. Furthermore an information system 7 is provided in the motor vehicle 1, which may be an audio system or a navigation system. The information system 7 is shown schematically in FIG. 1 as a unit arranged below the display 4. The information system 7 may be optionally arranged at another position in the motor vehicle 1.

As shown in FIG. 2 the display 4 shows an image 8 of the rearward environment of the motor vehicle 1. The display 4 is thus suitable for replacing a conventional inside mirror. Furthermore at least one parameter 9 is displayed on the display 4 associated with the information system 7 during a forward drive or a standstill of the motor vehicle 1. Thus while driving, the image 8 of the rearward environment also contains the parameter 9 associated with the information system so that both items of information are simultaneously shown on the display 4.

The parameter 9 displayed may be a selected radio station, a music title, a navigation map or the like. The examples given for the parameter 9 are to be understood as non-limiting because an expert familiar with the subject matter will automatically know that there exists a variety of displayable information which may originate from other sources. Typically this may include a telephone number of a hands-free equipment or a status of the motor vehicle 1 itself.

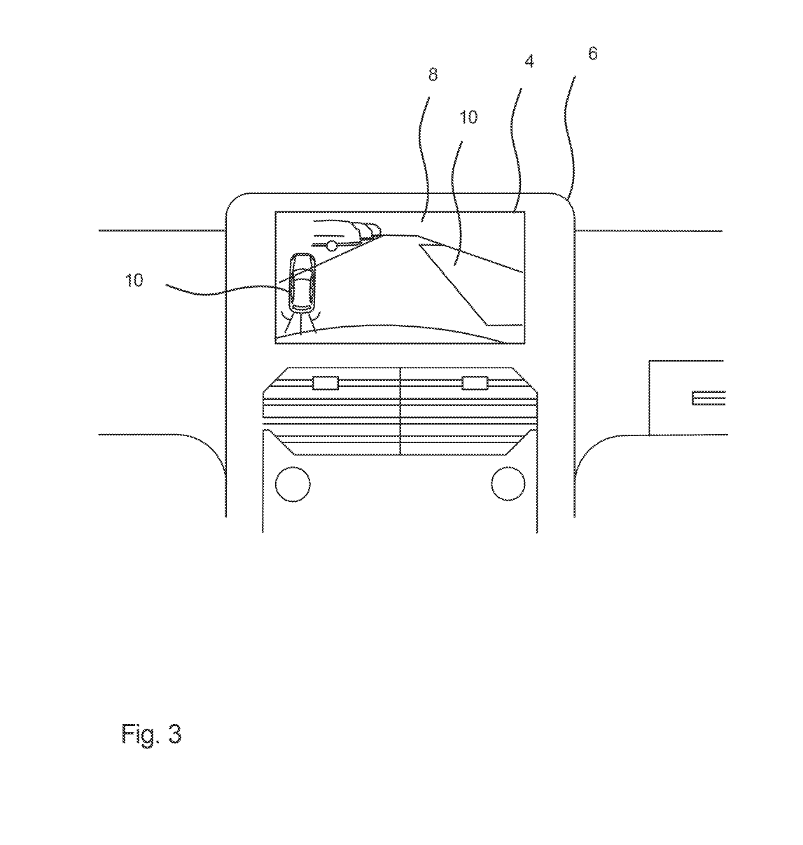

In a case where the motor vehicle 1 is reversed the display of the parameter 9 associated with the information system 7 on the display 4 is interrupted as shown in FIG. 3. Provision is made, in case of reversing, for information from a parking assistance system to be displayed on the display 4 as further parameters 10 in addition or as an alternative to, the image 8 of the rearward environment.

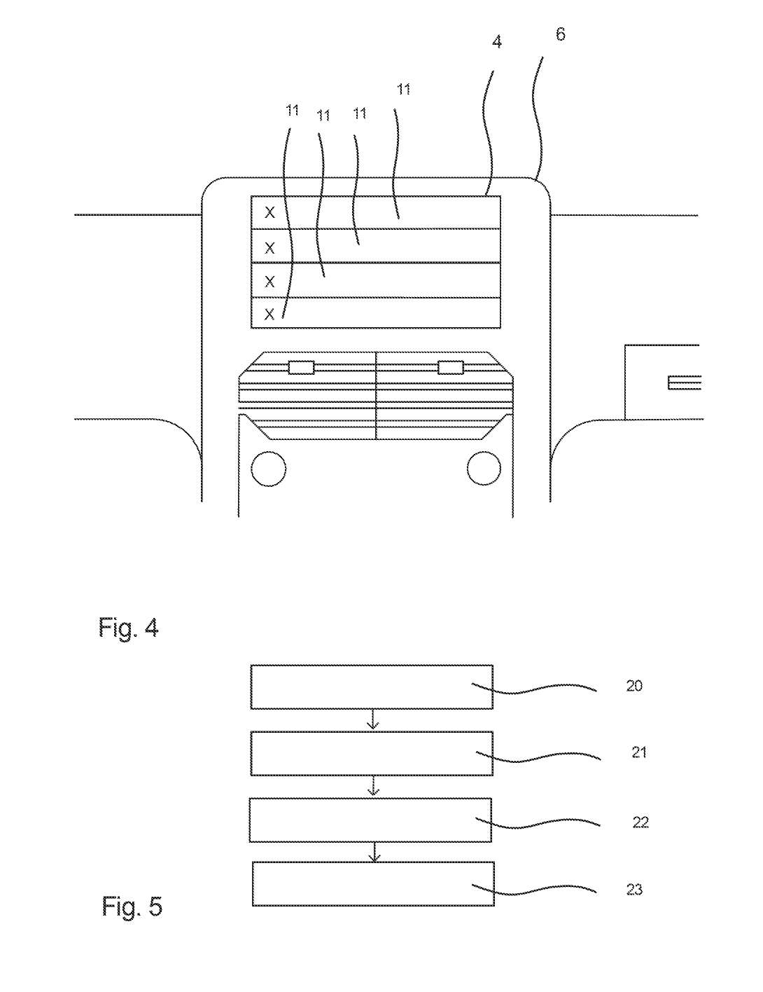

As shown in FIG. 4 generation of the image 8 of the rearward environment of the motor vehicle 1 is interrupted whilst an input into the information system 7 takes place. This is schematically shown in FIG. 4 by way a several input fields 11 which for example may be used to input a target address required by the navigation system.

The method will now be summarized once more by way of a flow diagram shown in FIG. 5. In step 20 an image 8 of the rearward environment of the motor vehicle 1 is generated by the reverse view camera system 3. In step 21 the information system 7 is provided in the motor vehicle 1. In step 22 the image 8 of the rearward environment is shown on the display 4. In step 23 at least one parameter 9 associated with the information system 7 is displayed on the display 4 while driving.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A method for displaying images of a reverse view camera system of a motor vehicle on a display, comprising:
generating an image of a rearward environment of the motor vehicle with the reverse view camera system;
providing an information system in the motor vehicle;
displaying the image of the rearward environment on the display; and
displaying at least one parameter associated with the information system on the display during a driving operation.

2. The method according to claim 1, wherein the information system an audio system.

3. The method according to claim 2, wherein the parameter displayed is a radio station.

4. The method according to claim 2, wherein the parameter displayed is a music title.

5. The method according to claim 1, wherein the information system is a navigation system.

6. The method according to claim 5, wherein the parameter displayed is a navigation map.

7. The method according to claim 1, wherein the generating of the image of the rearward environment of the motor vehicle is interrupted whilst an input is taking place at the information system.

8. The method according to claim 1, wherein the driving operation comprises a forward drive or a standstill of the motor vehicle (1).

9. The method according to claim 1, further comprising interrupting the displaying the parameter associated with the information system on the display when the driving operation comprises an act of reversing.

10. The method according to claim 9, further comprising displaying a reversing information of a parking assistance system as a further parameter on the display.

11. (canceled)

12. (canceled)

13. (canceled)

14. A non-transitory computer readable medium embodying a computer program product, said computer program product comprising:
a display program for displaying images of a reverse view camera system of a motor vehicle on a display, the display program configured to:
generate an image of a rearward environment of the motor vehicle with the reverse view camera system;
provide an information system in the motor vehicle;
display the image of the rearward environment on the display; and
display at least one parameter associated with the information system on the display during a driving operation.

15. The non-transitory computer readable medium embodying the computer program product according to claim 14, wherein the information system is an audio system.

16. The non-transitory computer readable medium embodying the computer program product according to claim 15, wherein the parameter displayed is a radio station.

17. The non-transitory computer readable medium embodying the computer program product according to claim 15, wherein the parameter displayed is a music title.

18. The non-transitory computer readable medium embodying the computer program product according to claim 14, wherein the information system is a navigation system.

19. The non-transitory computer readable medium embodying the computer program product according to claim 18, wherein the parameter displayed is a navigation map.

20. The non-transitory computer readable medium embodying the computer program product according to claim 18, wherein the display program is further configured interrupted the image of the rearward environment of the motor vehicle whilst an input is taking place at the information system.

21. The non-transitory computer readable medium embodying the computer program product according to claim 14, wherein the driving operation comprises a forward drive of the motor vehicle.

22. The non-transitory computer readable medium embodying the computer program product according to claim 14, wherein the display program is further configured to interrupt the display of the parameter associated with the information system on the display when the driving operation comprises an act of reversing.
